(19) United States
(12) Patent Application Publication
(10) Pub. No.: US 2018/0304906 A1
(43) Pub. Date: Oct. 25, 2018

(54) VEHICLE USER ADVICE SYSTEM

(71) Applicant: JAGUAR LAND ROVER LIMITED, COVENTRY, WARWICKSHIRE (GB)

(72) Inventors: FIONA POWELL, Warwickshire (GB); THOMAS POPHAM, Warwickshire (GB); LINH NGUYEN, Warwickshire (GB); ARUN PANICKER, Warwickshire (GB)

(73) Assignee: JAGUAR LAND ROVER LIMITED, Coventry Warwickshire (GB)

(21) Appl. No.: 15/769,651

(22) PCT Filed: Oct. 14, 2016
(86) PCT No.: PCT/EP16/74722

§ 371 Date: Apr. 19, 2018

(30) Foreign Application Priority Data
Oct. 23, 2015 (GB) 1518823.8

(51) Int. Cl. B60W 50/14; B60R 16/037; B60K 35/00; G09B 19/16

(52) U.S. Cl. CPC B60W 50/14; B60R 16/037; B60K 35/00; B60W 2550/402; B60K 2350/1024; B60W 2050/146; B60W 2540/28; G09B 19/167

(57) ABSTRACT

A user advice system for a vehicle (10) for providing a user with advice regarding vehicle operation, the system comprising; a monitoring module (30) arranged to monitor at least one vehicle parameter input; a determination module (26) arranged to determine, without a specific user request, a suggested user command relating to the operation of a sub-system of the vehicle (10), based on a suggestion policy (72) and the at least one vehicle parameter input; and, a notification module (14) arranged to notify the user of the suggested user command.

### TECHNICAL FIELD

The present disclosure relates to an advice system for a vehicle which provides the user with advice regarding operation of the vehicle to improve usability of the vehicle. Aspects of the invention relate to a user advice system for a vehicle, to a method of providing advice to a user of a vehicle, and to a vehicle.

### BACKGROUND

Within a vehicle cabin there will usually be a control system through which a user may interact with the on board systems and subsystems of the vehicle. Such ‘human-machine interface’ (HMI) devices may, for example, allow the user to control an air-conditioning system, adjust a vehicle entertainment system or select a driving mode of the vehicle.

Due to the increasing number of features installed on modern vehicles, current HMI systems may comprise a range of HMI devices, which may take the form of physical controls (which term is taken to include switches, buttons, control knobs, dials etc.) or display screens that may be touch enabled, for example.

In the case of physical controls, individual buttons must be smaller and/or multi-functional in order to accommodate the many features of modern vehicles onto the limited space provided by the dashboard of the vehicle. In the case of touch enabled devices the user must navigate through a number cascading menus in order to access various systems of the vehicle.

In either case, such systems have the effect of concealing the myriad features embedded within the vehicle's systems and sub-systems. Furthermore, the complexity of HMIs themselves may increase the workload on the vehicle user.

More advanced vehicles contain self-learning features that are able to detect patterns of usage by the user over a period of time, and use this information to predict when to automatically activate these features. However, such systems can only learn a vehicle user's usage pattern if the feature is engaged by the user for a sufficient number of times, such that the system is then able to gather enough information from which to make a suggestion.

Against this background, it is an object of the present invention to overcome or at least substantially alleviate the disadvantages associated with the prior art.

### SUMMARY OF INVENTION

Aspects and embodiments of the invention provide a user advice system for a vehicle, a method of providing advice to a user of a vehicle, and to a vehicle as claimed in the accompanying claims.

According to an aspect of the invention there is provided a user advice system for a vehicle, the system comprising; a monitoring module arranged to monitor at least one vehicle parameter input; a determination module arranged to determine, without a specific user request, a suggested user command relating to the operation of a sub-system of the vehicle, based on a suggestion policy and the at least one vehicle parameter input; and a notification module arranged to notify the user of the suggested user command.

The invention provides the driver, or other user of a vehicle, with advice regarding various aspects of the vehicle's operation, so as to prompt the user to select a suggested user command and thereby activate or control a feature of the vehicle, which they were otherwise unaware of or perhaps had not thought to make use of. By providing a suggested user command that relates to a self-learning feature of the vehicle, the user is encouraged to use such features more often and for longer periods of time, which enables the self-learning feature to gather more data and thereby learn to operate more effectively.

By notifying the user of a suggested user command, without a specific user request, the advice system can advantageously encourage the user to activate particular features of the vehicle at a time that is likely to be of optimal benefit to the user.

The determination module may be configured to receive the suggestion policy from a learning module, wherein the learning module is arranged to derive or learn the suggestion policy based on at least user identification data and the at least one vehicle parameter input.

The user advice system is based on a learning functionality so that by monitoring various user commands and vehicle parameters, a pattern of use is derived, which represents particular user preferences and tendencies. On the basis of the learnt behaviour, which is used to formulate the suggestion policy, the system is thereby able to present the user with suggested user commands that are particular to their user experience and which are likely to be of use to them, of interest, and/or to aid their comfort, safety and enjoyment of driving the vehicle.

Advantageously, the system identifies every user of the vehicle so that it can learn when, and to what extent, each user should be notified with a particular notification, such that each notification provides information that is relevant to each individual user. The system is also able to learn when, and in dependence on which vehicle parameter inputs, the user should be notified of a particular vehicle feature, thereby ensuring that each notification provides information that is relevant to the current status of the user and/or vehicle.

The suggested user command may comprise a rule for future operation of a vehicle sub-system. The rule may be to operate a sub-system of the vehicle in dependence on a given trigger condition being met. The rule may be to operate a sub-system of the vehicle in dependence on a plurality of trigger conditions being met. If selected by the user, the corresponding vehicle sub-system may always operate upon the trigger condition(s) being met.

This allows suggestion to a user to program the system to automatically operate one or more vehicle sub-systems in response to a selected trigger condition/conditions being met. In this way, it is possible to control future operation of the one or more vehicle sub-systems without requiring any intervention from the user at the desired time of use. Furthermore, once programmed, the suggestion policy may be updated such that suggested commands or rules which have been previously accepted and/or programmed by the user would not be suggested again, but would rather be activated automatically without further user input.

The determination module may include the learning module.

The suggestion policy may include instructions relating to one or more vehicle sub-systems. The suggestion policy may relate to one of the following vehicle sub-systems; a climate control sub-system, a vehicle safety sub-system, a navigation sub-system, a comfort sub-system, a communication and entertainment sub-system.

By categorizing the suggestion policy into various sub-systems of the vehicle, the learning module is able to provide suggested notifications that are particularly relevant to a given vehicle parameter input. Subsequently, the number of learning iterations required to learn the suggestion policy is reduced because, for a given vehicle parameter input, suggested notifications are provided from a predetermined list associated with a specific sub-system.

The monitoring module may include a vehicle status module arranged to receive vehicle status data, representative of the status of at least one sub-system of the vehicle and wherein the at least one vehicle parameter input includes the vehicle status data.

The vehicle status data may be a navigation signal, representative of a location of the vehicle, and the location of the vehicle may be a current location, a destination or an intermediate location on a route to a destination.

When learning the suggestion policy, the system may analyse the location of the vehicle, in relation to the notification to the user. Advantageously, therefore, each subsequent notification provides the user with information that is relevant to the location of the vehicle.

The monitoring module may include a user input module arranged to receive the at least one vehicle parameter input in the form of user input data representative of at least one user command relating to the operation of a sub-system of the vehicle, and wherein the at least one vehicle parameter input includes the user input data.

By analysing the input of a user, in relation to a previous notification, the system can ensure that each subsequent notification provides the user with information that is relevant to an individual user.

The user input data may include a frequency and/or a timing of user input data being input.

The user input data may be representative of a user navigation input, wherein the user navigation input is a current location, a destination or an intermediate location on a route to a destination.

The user input data may relate to any one of the following vehicle sub-systems: a climate control sub-system; a vehicle safety sub-system; a navigation sub-system; a comfort sub-system; a communication and entertainment sub-system.

The determination module may be arranged to receive an updated suggestion policy from an updating module to account for on-going interactions between a plurality of vehicle users and their vehicles.

Advantageously the updating module is able to provide an updated suggestion policy, based on the learnt behaviour of other users, which is then tailored to the personal needs of a particular user. Hence, the resulting suggestion policy is more likely to generate notifications that are useful and informative to an individual user.

The determination module may be configured to provide user identification data and/or vehicle parameter inputs, relating to a plurality of different users, to the updating module, wherein the updating module is configured to provide the updated suggestion policy based on user identification data and/or vehicle parameter inputs for the plurality of different users.

The user identification data, from each of the plurality of users, may be categorised into an identification class according to a predetermined user characteristic, wherein the predetermined user characteristic is representative of a user's age, employment status, marital status, gender, height or weight.

The updating module may be an external device, and wherein the determination module is arranged to communicate with the updating module over a wireless communication protocol, for example over 3G, 4G or WiFi via wireless or Bluetooth®.

Advantageously the updating module may be updated regularly and continually with vehicle parameter input and user identification data over a wireless interface. Consequently the updating module may also update the suggestion policy on a frequent and regular basis so that the suggested notifications remain relevant and informative to the user.

The user advice system may comprise a touch-enabled display.

According to a further aspect of the invention there is provided a vehicle comprising a user advice system according to the previously described aspect of the invention.

According to yet another aspect of the invention there is provided a method of providing advice to a user of a vehicle regarding operation of the vehicle, the method comprising: monitoring at least one vehicle parameter input; determining, without a specific user request, a suggested user command relating to the operation of a subsystem of the vehicle, based on a suggestion policy and the at least one vehicle parameter input; and notifying the user of the suggested user command.

Determining the notification may comprise receiving a suggestion policy from a learning module, wherein the learning module is arranged to derive or learn the suggestion policy based on at least the user identification data and the at least one vehicle parameter input.

It will be appreciated by someone skilled in the art that each of the updating, learning and determination modules may be provided within the vehicle. Alternatively, each module may be provided within an external device such as a smartphone, computer, server or smartwatch.

A further aspect of the invention relates to a non-transitory computer readable medium including computer readable program code, wherein the computer readable program code when executed causes a processor to implement the afore described method.

The determination, monitoring, notification, learning and updating modules may be provided as electronic data stored on a non-volatile memory component of a computer or logic system embedded within a control unit of the human-machine interface device.

As used herein, the term “control unit” will be understood to include both a single control unit or controller and a plurality of control units or controllers collectively operating to provide the required control functionality. A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

It will be appreciated that the foregoing represents only some of the possibilities with respect to the particular subsystems of a vehicle that may be included, as well as the arrangement of those subsystems with the control unit. Accordingly, it will be further appreciated that embodiments of a vehicle including other or additional subsystems and subsystem arrangements remain within the spirit and scope of the present invention. Additional sub-systems may include, for example, systems relating to any media infotainment, driver aid and/or control functions.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic side view drawing of a vehicle provided with a user advice system according to an embodiment of the invention;

FIG. 2 is a flow diagram illustrating the steps comprised in the method adopted by the learning module comprised in the user advice system of FIG. 1; and

FIG. 3 is a flow diagram illustrating the steps comprised in the method adopted by a global learning module in accordance with an embodiment of the invention.

### DETAILED DESCRIPTION OF EMBODIMENTS

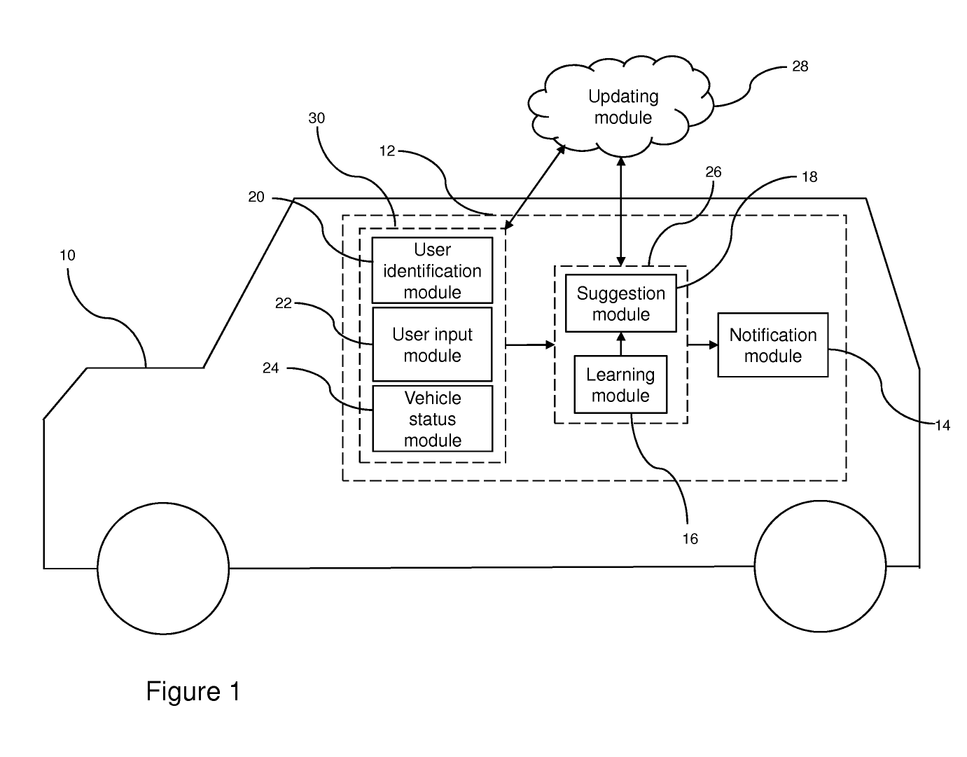

With reference to FIG. 1, a vehicle 10 such as a car includes control system 12 in the form of a user advice system including a notification module 14, a learning module 16 and a suggestion module 18. The user advice system 12 also includes a user identification module 20, a user input module 22 and a vehicle status module 24.

The notification module 14 includes a display screen (not shown) which may be used to display various information types to the user (e.g. climate information, time information, radio information, GPS mapping data etc.). The display screen forms a part of the human machine interface of the vehicle (HMI) and may be touch-screen enabled so as to allow the user to input various instructions and selections to the user advice system 12 via manual touch.

The learning module 16 and the suggestion module 18 may together form a determination module 26 for determining suggested user commands, as will be described in further detail below.

The user identification module 20, the user input module 22 and the vehicle status module 24 may together form a monitoring module 30, which may be independent from the user advice system, or may form an integral part of the user advice system.

The user identification module 20 is located in the vehicle 10 and is provided with a receiver (not shown). The receiver is arranged to receive user identification data from a near frequency communication device, such as an RFID chip held on a key fob for the vehicle 10, or on the key itself. Each user of the vehicle 10 has a designated key or key fob and so the presence of the key or key fob allows for the specific user to be identified by the user identification module 20. Alternatively, the user identification module 20 may identify the individual users of the vehicle 10 by monitoring an individual user's inputs into the HMI. These user identification data inputs may include, for example, the entering of a passcode or signature into the touch enabled display screen. During operation of the vehicle 10, the identification module 20 communicates the user identification data to the determination 26 and updating 28 modules.

The user input module 22 is in communication with two main types of user interfaces, the touch-enabled display screen (as described above) and one or more hard user-operable controls (e.g. buttons, switches, dials etc.). The display screen and control switches are part of an instrument cluster within the vehicle 10 enabling the user to interact with the sub-systems of the vehicle 10. The user may interact with the vehicle 10 via the use of on-screen buttons on the touch-enabled screen and via user gestures that may be captured by the touch-enabled screen. The display screen may display one or more interfaces through which a user may operate a climate control sub-system, a vehicle safety sub-system, a comfort sub-system and a communication and entertainment sub-system of the vehicle 10.

The user input module 22 monitors user interaction with the HMIs and provides the determination 26 and updating 28 modules with user input data related to each user interaction. The user input module 22 monitors a number of different aspects of the user's interaction with the interfaces. For example, the user input module 22 may monitor the user's interaction with the HMIs over time (e.g. over a period of a few days), over a number of vehicle journeys or over a number of ignition key cycles.

The vehicle status module 24 is in communication with sensors providing a variety of vehicle status data relating to the sub-systems of the vehicle 10. For example, the vehicle status module 24 receives data regarding the steering wheel position, the vehicle speed and the position of the accelerator and brake pedals. The vehicle status module 24 may receive further sensor data from other on-vehicle sensors, e.g. passenger status data via passenger seat sensors.

The vehicle status module 24 may also be configured to monitor one or more physical parameters of the vehicle 10, including the vehicle fuel level, the ambient light conditions and the temperature and humidity of the air inside and outside of the vehicle cabin. The vehicle status module 24 may be further configured to monitor one or more physical parameters relating to the terrain over which the vehicle 10 is traversing. The terrain monitor is able to distinguish between different types of terrain, such as sand, snow, mud, rock and tarmac.

The vehicle status module 24 is also in communication with a navigation sub-system (not shown), which includes a global positioning system (GPS) and which is arranged to determine the vehicle's location. The navigation sub-system also contains route information such as roads, hazards and points of interest. The vehicle status module 24 uses the vehicle location information to determine the vehicle's current location relative to the route information and other points of interest. Information relating to specific points of interest (for example shops, gymnasiums, restaurants and other facilities) to the route may also be monitored by the vehicle status module 24. The navigation sub-system is able to receive user navigation inputs from the user, via the HMI device. The user navigation input includes a current location, a destination or an intermediate location, on a route to a destination of the vehicle.

The determination module 26 is communicatively linked to the monitoring module 30 so that during operation, the determination module 26 is able to receive vehicle parameter and user identification data. The determination module 26 operates in two phases: a learning phase executed by the learning module 16, and a suggestion phase executed by the suggestion module 18.

The learning module 16 includes an algorithm that is able to analyse the information it receives from the monitoring module 30 in order to determine a vehicle usage trend, comprising a profile of the vehicle status and user input data. This includes, for example, determining how frequently a particular user input is received, the time of day and week at which a particular user input takes place, the location and status of the vehicle 10 and so on. Additionally, stored within the learning module 16 is a suggestion list, comprising user commands relating to the various functionalities of each vehicle sub-system. The suggestion list is arranged into categories, with each category corresponding to a specific sub-system of the vehicle 10.

The climate control category includes user commands for operating actuators of the vehicle climate control system, which includes for example, a set point value for a heating, ventilation and air conditioning (HVAC) unit and an activation command for a windscreen heating element.

The vehicle safety category lists commands for operating various elements of the vehicle safety sub-system, which includes for example, an activation command for a lane departure warning system, an automatic windscreen wiper system, an automatic headlight system and an automatic terrain response system.

The comfort category includes commands for operating various elements of the comfort sub-system, which includes for example, a mode selection command for a massage seat system and a temperature set point value for a seat heating/cooling system

The communication and entertainment category includes commands for operating various elements of the communication and entertainment sub-system of the vehicle 10, which includes for example, a destination set point for the GPS mapping system, a station selection command for a radio and a voice activation command for a car-phone system.

It will be appreciated by someone skilled in the art that the vehicle sub-system functionalities described herein do not represent an exhaustive list, and thus any number of user commands, relating to a variety of vehicle features and sub-systems may be monitored by the monitoring module.

It is noted that the sub-system categories of the suggestion list may overlap; such that a given suggested user command may be included in the suggestion list of two or more related sub-system categories.

During the learning phase, the learning module 16 presents a user with a notification comprising a list of possible suggested user commands, each relating to a function of the vehicle 10 (or vehicle sub-system). Upon detecting a vehicle parameter, relating to one of the vehicle sub-system categories, the learning module 16 selects a random selection of suggested user commands from the relevant category of the suggestion list and presents them to the user via the notification module 14. The learning module 16 analyses the user's response to the notification in conjunction with the monitored vehicle parameter and user identification data in order to derive or learn a suggestion policy.

In this way the learning module 16 is able to learn which suggested user command is most likely to be selected by the user, for a given vehicle status and/or user input. User identification data, gathered by the user identification module 20, is also used by the learning module 16 in order that a suggestion policy may be learnt that is specific to each user of the vehicle. Once sufficient data has been gathered in the learning phase the determination module 26 is then provided with the learnt suggestion policy for each user of the vehicle.

During the suggestion phase, the suggestion module 18 receives vehicle parameter and user identification data that corresponds to the usage of the vehicle by an individual user. The suggestion module 18 reads the suggestion policy in order to generate a specific notification, comprising a suggested user command, which is likely to be of use to the user. The notification may act as a prompt to the user, encouraging them to utilise a functionality of the vehicle that they may not have used before. Alternatively the notification may inform the user of a particular vehicle functionality that may compliment a functionality they have already activated.

Additionally or alternatively, the suggestion module 18 reads the suggestion policy in order to generate a specific notification, comprising a suggested user command in the form of a rule for future operation of a vehicle sub-system. The rule may be to utilise a given functionality of the vehicle in dependence on a trigger condition being met.

The learning phase may continue into the suggestion phase so that the learning module 16 is able to continually refine the suggestion policy according to the user's usage profile.

For example, consider a user driving towards a slip road of a motorway, the determination module 26 detects the location of the vehicle 10 and a subsequent increase in speed. Having joined the motorway and obtained a suitable cruising speed, the user then activates a cruise control system of the vehicle. The suggestion module 18 detects the input from the user and generates a notification, which asks the user, whether they would also like to activate the lane departure warning system. Additionally or alternatively, the suggestion module 18 detects the input from the user and generates a notification, which asks the user, whether they would like to set up a rule which activates the lane departure warning system automatically each time the user activates a cruise control system of the vehicle.

The monitoring module 30 and determination module 26 are additionally in communication with an updating module 28, via a wireless communication protocol such as 3G, 4G, WiFi. The updating module 28 comprises a data store for storing vehicle parameter and user identification data relating to a plurality of users.

The invention is best understood by reference to the following specific examples of how the determination module learns a suggestion policy for an individual user of the vehicle.

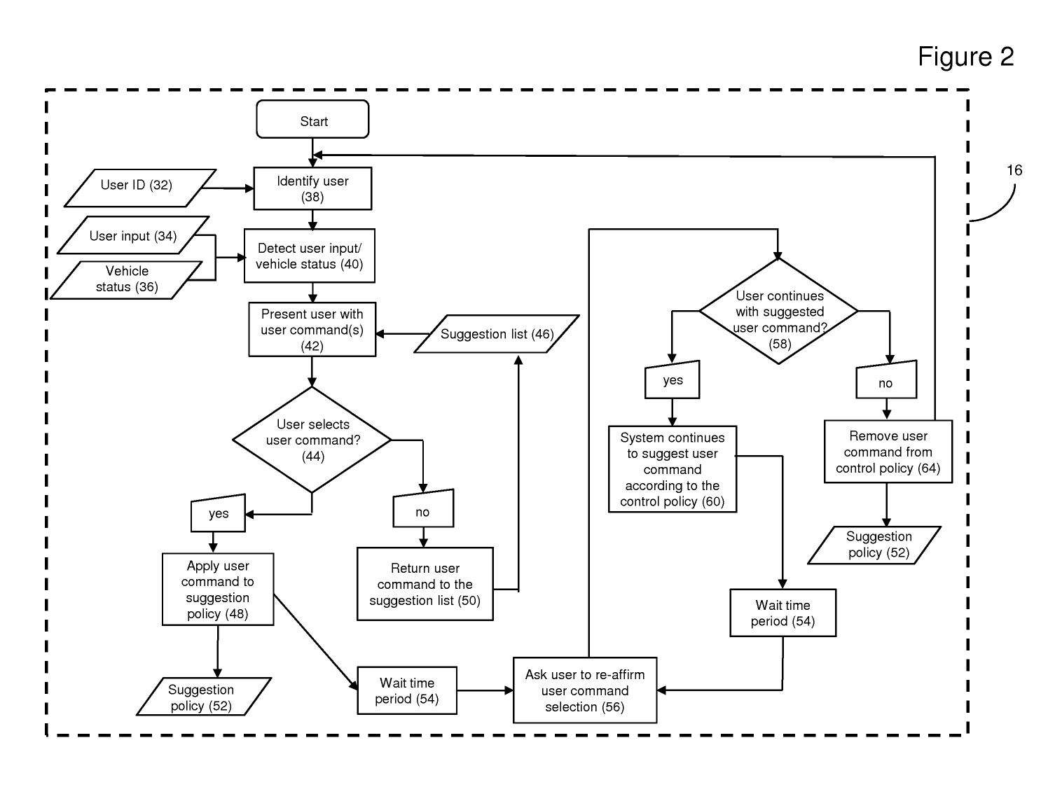

FIG. 2 is a flow diagram showing how the vehicle parameter and user identification data is utilised when learning a suggestion policy for an individual user of the vehicle. During operation, the learning module 16 employs a learning algorithm to build up the suggestion policy for each individual user. The learning algorithm is based on the known principle of Bayesian inference. It is noted that other learning algorithms that are known in the art may be used to build up the suggestion policy; including, for example, learning methods that employ artificial neural networks, associated rules, regression, clustering and instance-based learning.

The learning algorithm starts by receiving user identification data 32 that enables the identity of the user to be determined at step 38 by the system. The user identification data may be received from the user's key fob as they approach or enter the vehicle. In step 40, user input data 34 is received from a user inputting a command into one or more of the HMIs. Additionally, vehicle status data 36 is received, from a plurality of vehicle sensors, relating to the status of various vehicle sub-systems.

In step 42, the vehicle parameter data is analysed, in order to determine which sub-system category it is most closely related to. A random selection of suggested commands is then chosen from the relevant sub-system category and presented to the user via one or more of the HMIs.

In step 44, the user is required to select whether they wish to execute one of the suggested user commands. If the user selects one of the suggested commands it will be applied to the suggestion policy (step 48). The selected user command is then executed by the relevant vehicle sub-system. Any suggested user commands that are not selected by the user are returned to the suggestion list (step 50); ready to be selected again in the future.

After waiting a period of time, the user is notified of their previously selected user suggestion and asked to confirm their selection (step 56). If the user confirms their earlier selection the suggested user command is returned to the suggestion policy (step 60) together with an updated set of vehicle parameter data. The system then waits a further predetermined period of time before asking the user to re-confirm their selection once again (step 56). This confirmation process is repeated until sufficient data has been gathered, such that the confirmed user command can be fixed within the suggestion policy.

If the user declines their earlier selection, the suggested user command is removed from the suggestion policy and returned to the suggestion list (step 64). The learning module 16 then returns to the start of the learning algorithm and awaits the detection of a new vehicle parameter and/or user identification data input, from which it will start the learning stage cycle again.

In the event that the user declines to select any suggestion, for example, if the user does not wish to be presented with notifications, the notification is withdrawn from the display. After a predetermined time period, the same notification will be presented again to the user. Alternatively, the user may select an “ask me later” user command, which will cause the notification to be hidden for a period of time, before again being presented to the user.

The notification may comprise an on-screen prompt (which may be text based, icon based or a mixture of the two) or an audio prompt. Additional notification types may comprise altering the appearance of an HMI (e.g. illumination of a physical button or illuminating an on-screen button or additionally changing the size of an on-screen button). It is noted that during the learning and/or suggestion phase, a user may be presented with the notification during or at the end of a given user interaction. The notification may also be presented to the user, the next time the determination module detects that the user is performing the given user interaction again, or alternatively at a separate time when the determination module can be confident that the user will not be distracted, for example, when the vehicle is parked.

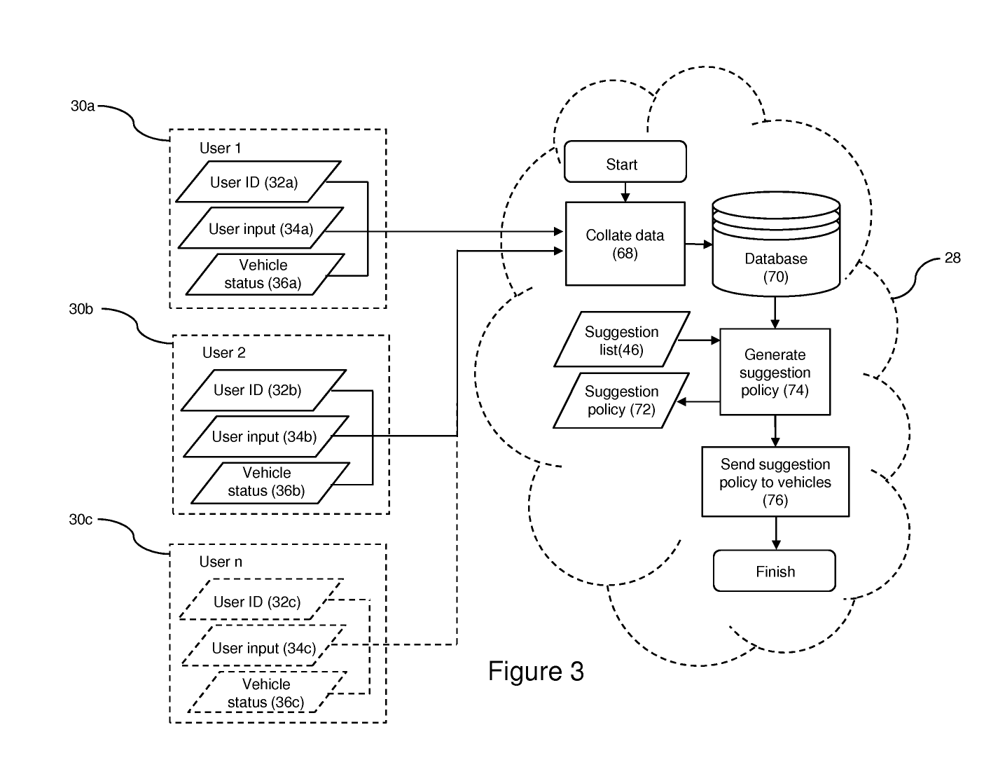

With reference to FIG. 3, a flow chart of a method according to the present invention for updating the suggestion policy is shown.

The updating module 28 is used to update the suggestion policy based on vehicle parameter and user identification data that has been gathered from a plurality of users in a plurality of vehicles 10. The updating module 28 may be updated regularly and continually with vehicle parameter and user identification data, which can then be used to calculate a suggestion policy.

In step 68, the updating module 28 receives user identification data (32a, 32b, 32c), user input data (34a, 34b, 36c) and vehicle status data (36a, 36b, 36c) from the monitoring modules of a plurality of vehicles (30a, 30b, 30c). The vehicle parameter and user identification data may be representative of individual users of a single vehicle or of different vehicles. The data from each of the individual users is collated into a central database 70.

In step 74, the vehicle parameter and user identification data is analysed in conjunction with a “factory” suggestion list 46, in order to produce a “global” suggestion policy 72. In step 76, the “global” suggestion policy 72 is then downloaded to the determination module (not shown) of each vehicle at regular intervals, in order to ensure that each suggestion policy is kept up to date.

The updating module 28 is therefore able to provide an updated suggestion policy 72, which is based on the interactions of other users. The determination module can generate suggested user commands that are tailored to the personal needs of a particular user but, which are derived from the experiences of a plurality of other users. The resulting suggestion policy is therefore more likely to generate useful suggested user commands for a given set of vehicle parameter data inputs. Alternatively, the “factory” suggestion list 46 may be ordered so that the suggested user command is presented to the user, based on the types of user commands that are most commonly selected by users with matching user identification data to the present user, thereby increasing the likelihood that a user will be presented with a suggested user command that is relevant or of interest to them.

The updating module 28 utilises the user identification data to categorise the received user input and/or vehicle parameter data into an activation class according to a distinguishable characteristic of the user; wherein the user characteristic is representative of a user's age, employment status, marital status, gender, height or weight, for example. Alternatively the received user input and/or vehicle parameter data may be categorised into an identification class according to a combination of the aforementioned user characteristics.

During operation, the determination module uses the updated suggestion policy to determine a suggested user command based on the teaching of the updated suggestion policy, which has been derived from user command and/or vehicle parameter inputs associated with a plurality of users, whose user identification data are considered relevant to the present user.

In an example of the operation of one embodiment of the invention in which a user has driven to a gymnasium or sports centre, the monitoring module 30 detects that a user has entered the vehicle and activated the HVAC sub-system in order to cool themselves down. The determination module 26 detects the activation of the HVAC system, and presents the user with a notification, asking whether they would also like to activate the seat cooling system. The notification may ask the user whether they would also like to set up a rule which automatically activates the seat cooling system of the vehicle upon the trigger condition that the HVAC sub-system has been activated. As the suggestion policy 72 has been updated using information from a plurality of users, the determination module (not shown) is able to provide a suggested user command, based on the experiences of other users, namely that the seat cooling system is often activated in conjunction with the HVAC system when a user has returned to the vehicle having just visited the gymnasium.

In a further embodiment of the invention, the vehicle status module 24 is able to provide information regarding the behaviour of the user, based on various driving style indicators. For example, vehicle status module 24 may provide an indication to the determination module 26 that the user is driving in a determined manner, and so is in a hurry and agitated and less open to receive notifications and alerts, or that the user is driving passively and cautiously, hence the user may be more inclined to take notice of notifications and alerts provided by the notification module 14.

According to a yet further aspect of the invention, the monitoring module 30 may be communicatively linked to an external device such as a smartphone, computer or smartwatch over a physical or medium wireless communication protocol, for example 3G, 4G or WiFi. The vehicle status module 24 may receive vehicle status data from sensors that are not part of the vehicle 10, e.g. smartphone sensor data. The user identification module 20 may receive user related data including, for example, a calendar event from a user's calendar which may be relevant to a particular usage of the vehicle 10. The calendar event may be selected from the list including: a birthday, a public holiday, a celebration, an anniversary. During operation the determination module 26 is able to generate a suggested user command based on the calendar event of an individual user in dependence on the teaching of the suggestion policy. The user input module 22 may receive user input data representative of a user command. Alternatively, the user command may be pre-programmed into the external device such that the user inputs are received by the monitoring module 30, in dependence on the external device being detectably in range of the vehicle 10 Therefore as the user approaches or enters the vehicle 10, the pre-defined user command, or commands, may be applied to the various sub-systems of the vehicle 10. The determination module 26 may then generate a user suggested command, based on the detected user inputs, in dependence on the teaching of the suggestion policy.

It will be appreciated by someone skilled in the art that the invention could be modified to take many other alternative forms without departing from the scope of the claims.

1. A user advice system for a vehicle for providing a user of the vehicle with advice regarding operation of the vehicle, the user advice system comprising:
a monitoring module arranged to monitor at least one vehicle parameter input;
a determination module arranged to determine, without a specific user request, a suggested user command relating to the operation of a sub-system of the vehicle, based on a suggestion policy and the at least one vehicle parameter input; and
a notification module arranged to notify the user of the suggested user command;
wherein the determination module is arranged to receive an updated suggested policy from an updating module to account for on-going interactions between a plurality of vehicle users and their vehicles,
wherein the determination module is configured to provide user identification data and/or vehicle parameter inputs, relating to a plurality of different users, to the updating module, and
wherein the user identification data, from each of the plurality of users, is categorised into an identification class according to a predetermined user characteristic.

2. A system as claimed in claim 1, wherein the determination module is configured to receive the suggestion policy from a learning module, wherein the learning module is arranged to derive or learn the suggestion policy based on at least the user identification data and the at least one vehicle parameter input.

3. A system as claimed in claim 2, wherein the determination module includes the learning module.

4. A user advice system as claimed in claim 1, wherein the suggestion policy includes instructions relating to one or more vehicle sub-systems.

5. A system as claimed in claim 4, wherein the suggestion policy relates to one or more of the following vehicle sub-systems: a climate control sub-system; a vehicle safety sub-system; a navigation sub-system; a comfort sub-system; a communication and entertainment sub-system.

6. A system as claimed in claim 1, wherein the monitoring module includes a vehicle status module arranged to receive vehicle status data, representative of the status of at least one sub-system of the vehicle and wherein the at least one vehicle parameter input includes the vehicle status data.

7. A system as claimed in claim 6, wherein the vehicle status data is a navigation signal representative of a location of the vehicle.

8. A system as claimed in claim 7, wherein the location of the vehicle is a current location, a destination or an intermediate location on a route to a destination.

9. A system as claimed in claim 1, wherein the monitoring module includes a user input module arranged to receive the at least one vehicle parameter input in the form of user input data representative of at least one user command relating to the operation of a sub-system of the vehicle, and wherein the at least one vehicle parameter input includes the user input data.

10. A system as claimed in claim 9, wherein the user input data includes a frequency and/or a timing of user input data being input.

11. A system as claimed in claim 9, wherein the user input data is representative of a user navigation input, wherein the user navigation input is a current location, a destination or an intermediate location on a route to a destination.

12. A system as claimed in claim 9, wherein the user input data relates to any one of the following vehicle sub-systems: a climate control sub-system; a vehicle safety sub-system; a navigation sub-system; a comfort sub-system; a communication and entertainment sub-system.

13. (canceled)

14. A system as claimed in claim 1, wherein the updating module is configured to provide the updated suggestion policy based on user identification data and/or vehicle parameter inputs for the plurality of different users.

15. A system as claimed in claim 14, wherein the predetermined user characteristic is representative of a user's age, employment status, marital status, gender, height or weight.

16. A system as claimed in claim 1, wherein the updating module is an external device, and wherein the determination module is arranged to communicate with the updating module via a wireless communication protocol, for example over 3G, 4G or WiFi via wireless or Bluetooth®.

17. A system as claimed in claim 1, comprising a touch-enabled display.

18. A vehicle comprising a user advice system as claimed in claim 1.

19. A method of providing advice to a user of a vehicle regarding operation of the vehicle, the method comprising;
monitoring at least one vehicle parameter input;
determining, without a specific user request, a suggested user command relating to the operation of a subsystem of the vehicle, based on a suggestion policy and the at least one vehicle parameter input; and
notifying the user of the suggested user command;
receiving, at a determination module, an updated suggested policy from an updating module to account for on-going interactions between a plurality of vehicle users and their vehicles;
providing, from the determination module, user identification data and/or vehicle parameter inputs, relating to a plurality of different users, to the updating module;
and,
categorising the user identification data, from each of the plurality of users, into an identification class according to a predetermined user characteristic.

20. A method as claimed in claim 19, wherein determining the notification comprises receiving a suggestion policy from a learning module, wherein the learning module is arranged to derive or learn the suggestion policy based on at least the user identification data and the at least one vehicle parameter input.

21. (canceled)

22. (canceled)

23. (canceled)

24. A user advice system for a vehicle for providing a user of the vehicle with advice regarding operation of the vehicle, the user advice system comprising:
a monitoring module arranged to monitor at least one vehicle parameter input;
a determination module arranged to receive user related data including a calendar event from a user's calendar and arranged to determine, based on a suggestion policy, at least one vehicle parameter input and the calendar event, and without a specific user request, a suggested user command relating to the operation of a sub-system of the vehicle; and
a notification module arranged to notify the user of the suggested user command.
